(19) United States
(12) Patent Application Publication
(10) Pub. No.: US 2005/0287363 A1
(43) Pub. Date: Dec. 29, 2005

(54) Heat-activable adhesive tape for bonding electronic components and conductor tracks

(75) Inventors: Christian Ring, Hamburg (DE); Thorsten Krawinkel, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 11/120,681

(22) Filed: May 3, 2005

(30) Foreign Application Priority Data
Jun. 28, 2004 (DE) 10 2004 031 188.9

(51) Int. Cl. B32B 7/12; C08F 8/00; B32B 15/04; C08L 83/00

(52) U.S. Cl. 428/346; 428/343; 428/355 R; 428/355 EP; 428/355 BL

(57) ABSTRACT

Heat-activable adhesive tape for bonding electronic components and conductor tracks, with an adhesive composed at least of a) an acid-modified or acid-anhydride-modified vinylaromatic block copolymer and b) an epoxide compound.

The invention relates to a heat-activable adhesive of low fluidity at high temperatures for bonding electronic components and flexible printed conductor tracks (flexible printed circuit boards, FPCBs).

Flexible printed circuit boards are nowadays employed in a multiplicity of electronic devices such as mobile phones, radios, computers, printers and many more. They are constructed from layers of copper and a high-melting resistant thermoplastic: mostly polyimide, less often polyester. These FPCBs are frequently produced using adhesive tapes with particularly exacting requirements. On the one hand, for producing the FPCBs, the copper foils are bonded to the polyimide films; on the other hand, individual FPCBs are also bonded to one another, in which case polyimide bonds to polyimide. In addition to these applications, the FPCBs are also bonded to other substrates.

The adhesive tapes used for these bonding tasks are subject to very exacting requirements. Since very high bond performances must be attained, the adhesive tapes used are generally heat-activable tapes, which are processed at high temperatures. These adhesive tapes must not emit volatile constituents in the course of this high temperature load during the bonding of the FPCBs, which often takes place at temperatures around 200° C. In order to achieve a high level of cohesion the adhesive tapes ought to crosslink during this temperature load. High pressures during the bonding operation make it necessary for the flowability of the adhesive tapes at high temperatures to be low. This is achieved by high viscosity in the uncrosslinked adhesive tape or by very rapid crosslinking. Moreover, the adhesive tapes must also be solder bath resistant, in other words must for a short time withstand a temperature load of 288° C.

For this reason the use of pure thermoplastics is not rational, despite the fact that they melt very readily, ensure effective wetting of the bond substrates and lead to very rapid bonding within a few seconds. At high temperatures, though, they are so soft that they tend to swell out of the bondline under pressure in the course of bonding. Accordingly there is no solder bath resistance either.

For crosslinkable adhesive tapes it is usual to use epoxy resins or phenolic resins, which react with specific hardeners to form polymeric networks. In this specific case the phenolic resins cannot be used, since in the course of crosslinking they generate elimination products, which are released and, in the course of curing or, at the latest, in the solder bath, lead to blistering.

Epoxy resins are employed primarily in structural adhesive bonding and, after curing with appropriate crosslinkers, produce very brittle adhesives, which indeed achieve high bond strengths but possess virtually no flexibility.

Increasing the flexibility is vital for use in FPCBs. On the one hand the bond is to be made using an adhesive tape which ideally is wound onto a roll; on the other hand the conductor tracks in question are flexible, and must also be bent, readily apparent from the example of the conductor tracks in a laptop, where the foldable screen is connected via FPCBs to the further circuits.

Flexibilizing these epoxy resin adhesives is possible in two ways. First, there exist epoxy resins flexibilized with elastomer chains, but the flexibilization they experience is limited, owing to the very short elastomer chains. The other possibility is to achieve flexibilization through the addition of elastomers, which are added to the adhesive. This version has the drawback that the elastomers are not crosslinked chemically, meaning that the only elastomers that can be used are those which at high temperatures still retain a high viscosity.

Because the adhesive tapes are produced generally from solution it is frequently difficult to find elastomers of a sufficiently long-chain nature not to flow at high temperatures while being still of a sufficiently short-chain nature that they can be brought into solution.

Production via a hotmelt operation is possible but very difficult in the case of crosslinking systems, since it is necessary to prevent premature crosslinking during the production operation.

The prior art further discloses, in WO 00/01782 A1, an electrically conductive, thermoplastic and heat-activable adhesive sheet comprising
i) a thermoplastic polymer, with a fraction of from 30% to 89.9% by weight,
ii) one or more tackifying resins, with a fraction of from 5% to 50% by weight, and/or
iii) epoxy resins with hardeners, possibly accelerators as well, with a fraction of from 5% to 40% by weight,
iv) silverized glass beads or silver particles, with a fraction of from 0.1% to 40% by weight.

A development was disclosed by DE 198 53 805 A1, with the electrically conductive, thermoplastic and heat-activable adhesive sheet comprising
i) a thermoplastic polymer, with a fraction of at least 30% by weight,
ii) one or more tackifying resins, with a fraction of from 5% to 50% by weight, and/or
iii) epoxy resins with hardeners, possibly also accelerators, with a fraction of from 5% to 40% by weight,
iv) metallized particles, with a fraction of from 0.1% to 40% by weight,
v) non-deformable or difficult-to-deform spacer particles, with a fraction of from 1% to 10% by weight, which do not melt at the bonding temperatures of the adhesive sheet.

In preferred embodiments the thermoplastic polymers are in each case thermoplastic polyolefins, polyesters, polyurethanes or polyamides or modified rubbers, such as nitrile rubbers in particular.

It is an object of the invention, therefore, to provide an adhesive tape which is heat-activable, crosslinks in the heat, possesses a low viscosity in the heat, displays effective adhesion to polyimide and in the uncrosslinked state is soluble in organic solvents.

This object is achieved, surprisingly, by means of an adhesive tape as described hereinbelow.

The invention accordingly provides an adhesive tape for bonding electronic components and flexible conductor tracks, comprising an adhesive composed at least of an acid-modified or acid-anhydride-modified vinylaromatic block copolymer and an epoxy resin.

The general expression “adhesive tape” for the purposes of this invention embraces all sheetlike structures, such as two-dimensionally extended sheets or sheet sections, tapes with extended length and limited width, tape sections, diecuts and the like.

Adhesives based on acid-anhydride-modified block copolymers and epoxy resins are known from U.S. Pat. No. 5,369,167 A. A description is given of a method of preparing these compound formulations. Hardeners, moreover, are used for crosslinking the epoxy resin. An adhesive is not mentioned.

Similar adhesives are also described in JP 57/149369 A1. Again, a hardener is needed for the epoxy resin. An adhesive tape is not described in any detail.

An advantage of the adhesives of the invention is that the elastomer actually crosslinks chemically with the resin; there is no need to add a hardener for the epoxy resin, because the elastomer itself acts as hardener.

Adhesives employed are preferably those based on block copolymers comprising polymer blocks predominantly formed of vinylaromatics (A blocks), preferably styrene, and those predominantly formed by polymerization of 1,3-dienes (B blocks), preferably butadiene and isoprene. Not only homopolymer but also copolymer blocks are useful in accordance with the invention. Resultant block copolymers may contain identical or different B blocks, which may be partly, selectively or fully hydrogenated. Block copolymers may have a linear A-B-A structure. Likewise suitable for use are block copolymers of radial design and also star-shaped and linear multiblock copolymers. Further components which may be present include A-B diblock copolymers. Block copolymers of vinylaromatics and isobutylene are likewise suitable for use in accordance with the invention. All of the aforementioned polymers may be utilized alone or in a mixture with one another.

At least a fraction of the block copolymers employed must have been acid-modified or acid-anhydride-modified, the modification taking place principally through free-radical graft copolymerization of unsaturated monocarboxylic and polycarboxylic acids or anhydrides, such as, for example fumaric acid, itaconic acid, citraconic acid, acrylic acid, maleic anhydride, itaconic anhydride or citraconic anhydride, preferably maleic anhydride. The fraction of acid and/or acid-anhydride is preferably between 0.5 and 4 percent by weight, based on the overall block copolymer.

Commercially such block copolymers are available for example under the name Kraton™ FG 1901 and Kraton™ FG 1924 from Shell, or Tuftec™ M 1913 and Tuftec™ M 1943 from Asahi.

Epoxy resins are usually understood to be not only monomeric but also oligomeric compounds containing more than one epoxide group per molecule. They may be reaction products of glycidyl esters or epichlorohydrin with bisphenol A or bisphenol F or mixtures of these two. Likewise suitable for use are epoxy novolak resins, obtained by reacting epichlorohydrin with the reaction product of phenols and formaldehyde. Monomeric compounds containing two or more epoxide end groups, used as diluents for epoxy resins, can also be employed. Likewise suitable for use are elastically modified epoxy resins or epoxide-modified elastomers, such as, for example, epoxidized styrene block copolymers, an example being Epofriend from Daicel.

Examples of epoxy resins are Araldite™ 6010, CY-281™, ECN™ 1273, ECN™ 1280, MY 720, RD-2 from Ciba Geigy, DER™ 331, 732, 736, DEN™ 432 from Dow Chemicals, Epon™ 812, 825, 826, 828, 830 etc. from Shell Chemicals, HPT™ 1071, 1079, likewise from Shell Chemicals, and Bakelite™ EPR 161, 166, 172, 191, 194 etc. from Bakelite AG.

Commercial aliphatic epoxy resins are, for example, vinylcyclohexane dioxides such as ERL-4206, 4221, 4201, 4289 or 0400 from Union Carbide Corp.

Elasticized elastomers are available from Noveon under the name Hycar.

Epoxy diluents, monomeric compounds containing two or more epoxide groups, are for example Bakelite™ EPD KR, EPD Z8, EPD HD, EPD WF, etc. from Bakelite AG or Polypox™ R 9, R12, R 15, R 19, R 20 etc. from UCCP.

Although, as described above, the addition of crosslinkers is not necessary, it is nevertheless possible to add further hardeners. Hardeners used here should only be substances containing acid or acid anhydride groups, since the amines and guanidines used primarily for epoxy crosslinking react with the acid anhydride and accordingly the number of reactive groups is lowered.

Besides the acid-modified or acid-anhydride-modified vinylaromatic block copolymers already mentioned it is also possible to add further acids or acid anhydrides in order to achieve a high degree of crosslinking and hence an even further improved cohesion. In this context it is possible to use not only monomeric acid anhydrides and acids as described in U.S. Pat. No. 3,970,608 A but also acid-modified or acid-anhydride-modified polymers and also acid-anhydride-containing copolymers such as polyvinyl methyl ether-maleic anhydride copolymers, obtainable for example under the name Gantrez™, sold by ISP.

The chemical crosslinking of the resins with the elastomers produces very high strengths within the adhesive film. The bond strengths to the polyimide as well, however, are extremely high.

In order to increase the adhesion it is also possible to add tackifier resins compatible with the elastomer block of the block copolymers.

Examples of tackifiers which can be used in pressure-sensitive adhesives of the invention include non-hydrogenated, partially hydrogenated or fully hydrogenated resins based on rosin and rosin derivatives, hydrated polymers of dicyclopentadiene, non-hydrogenated or partially, selectively or fully hydrogenated hydrocarbon resins based on C₅, C₅/C₉ or C₉ monomer streams, polyterpene resins based on α-pinene and/or β-pinene and/or δ-limonene, hydrogenated polymers of preferably pure C₈ and C₉ aromatics. Aforementioned tackifier resins may be used either alone or in a mixture.

Further additives which can be used typically include:
primary antioxidants, such as sterically hindered phenols
secondary antioxidants, such as phosphites or thioethers
in-process stabilizers, such as C-radical scavengers
light stabilizers, such as UV absorbers or sterically hindered amines
processing assistants
endblock reinforcer resins
fillers, such as silicon dioxide, glass (ground or in the form of beads), aluminium oxides, zinc oxides, calcium carbonates, titanium dioxides, carbon blacks, metal powders, etc.
colour pigments and dyes and also optical brighteners
if desired, further polymers, preferably elastomeric in nature.

An advantage of these systems is the very low softening temperature, which is a result of the softening point of the polystyrene in the endblocks of the block copolymers. Since the elastomers are also incorporated into a polymeric network during the crosslinking reaction, and since this reaction is relatively fast at the high temperatures of up to 200° C. that are normally used for bonding FPCBs, there is no escape of adhesive from the bondline. By adding compounds known as accelerators it is possible to increase the reaction rate further.

Examples of possible accelerators include the following:
tertiary amines, such as benzyldimethylamine, dimethylaminomethylphenol and tris(dimethylaminomethyl)phenol
boron trihalide-amine complexes
substituted imidazoles
triphenylphosphine

Ideally the acid-modified and/or acid-anhydride-modified elastomers and epoxy resins are employed in a proportion such that the molar fraction of epoxide groups and anhydride groups is just equivalent. Where elastomers with only low levels of modification are used, and where low molecular mass epoxy resins with a low epoxide equivalent are employed, the amounts of epoxy resin employed in this case are very low: less than 10% by weight, based on the modified styrene block copolymer.

The ratio between anhydride groups and epoxide groups, however, can be varied within wide ranges; for sufficient crosslinking, neither of the two groups should be present in more than a fourfold molar excess.

To produce the adhesive tape the constituents of the adhesive are dissolved in a suitable solvent, toluene for example, or mixtures of mineral spirit 70/90 and acetone, and the solution is coated onto a flexible substrate provided with a release layer, such as a release paper or release film, for example, and the coating is dried, so that the composition can be easily removed again from the substrate. Following appropriate converting, diecuts, rolls or other shapes can be produced at room temperature. Corresponding shapes are then adhered, preferably at elevated temperature, to the substrate to be bonded, polyimide for example.

It is also possible to coat the adhesive directly onto a polyimide backing. Adhesive sheets of this kind can then be used for masking copper conductor tracks for FPCBs.

It is not necessary for the bonding operation to be a one-stage process; instead, the adhesive tape can first be adhered to one of the two substrates by carrying out hot lamination. In the course of the actual hot bonding operation with the second substrate (second polyimide sheet or copper foil), the resin then fully or partly cures and the bondline reaches the high bond strength.

The admixed epoxy resins should preferably not yet enter into any chemical reaction at the lamination temperature, but instead should react only on hot bonding, with the acid or acid anhydride groups.

### EXAMPLES

The invention is described in more detail below by a number of examples, without restricting the invention in any way whatsoever.

### Example 1

A mixture of 92.5 g of Kraton™ FG 1901 (maleic-anhydride-modified styrene-ethylene/butylene-styrene block copolymer containing 30% by weight block polystyrene and about 2% by weight maleic anhydride) and 7.5 g of Bakelite™ EPR 191 (epoxy resin) is dissolved in toluene and coated from solution onto a release paper, siliconized with 1.5 g/m³, and dried at 110° C. for 15 minutes. The thickness of the adhesive layer is 25 μm.

### Example 2

A mixture of 97.2 g of Tuftec™ M 1913 (maleic-anhydride-modified styrene-ethylene/butylene-styrene block copolymer containing 30% by weight block polystyrene and about 2% by weight maleic anhydride) and 2.8 g of Polypox™ R 9 (epoxy resin diluent) is dissolved in toluene and coated from solution onto a release paper, siliconized with 1.5 g/m³, and dried at 110° C. for 15 minutes. The thickness of the adhesive layer is 25 μm.

### Example 3

A mixture of 87.4 g of Kraton™ FG 1901, 2.6 g of Bakelite™ EPR 161 (epoxy resin) and 10 g of Reglalite™ R 1100 (hydrogenated hydrocarbon resin having a softening point of approximately 100° C. from Eastman) is dissolved in toluene and coated from solution onto a release paper, siliconized with 1.5 g/m³, and dried at 110° C. for 15 minutes. The thickness of the adhesive layer is 25 μm.

### Comparative Example 4

A mixture of 80 g of Kraton™ G 1650 (non-modified styrene-ethylene/butylene-styrene block copolymer analogous to Kraton™ FG 1901), 14 g of Bakelite™ EPR 161 and 6 g of maleic anhydride is dissolved in toluene and coated from solution onto a release paper, siliconized with 1.5 g/m³, and dried at 110° C. for 15 minutes. The thickness of the adhesive layer is 25 μm.

Bond of FPCBs with the Adhesive Tape Produced

Two FPCBs were bonded using in each case one of the adhesive tapes produced in accordance with Examples 1 to 4. For this purpose the adhesive tape was laminated onto the polyimide sheet of the polyimide/copper foil FPCB laminate at 100° C. Subsequently a second polyimide sheet of a further FPCB was bonded to the adhesive tape and the whole assembly was compressed in a heatable Burkle press at 200° C. and a pressure of 1.5 MPa for one hour.

Test Methods

The properties of the adhesive sheets produced in accordance with the examples specified above were investigated by the following test methods.

T-peel Test with FPCB

Using a tensile testing machine from Zwick, the FPCB/adhesive tape/FPCB assemblies produced in accordance with the process described above were peeled from one another at an angle of 180° and with a rate of 50 mm/min, and the force required, in N/cm, was measured. The measurements were made at 20° C. and 50% relative humidity. Each measurement value was determined three times.

Temperature Stability

In analogy to the T-peel test described, the FPCB assemblies produced in accordance with the process described above were suspended so that one side of the assembly was suspended while on the other side a weight of 500 g was attached. The static peel test takes place at 70° C. The parameter measured is the static peel travel in mm/h.

Solder Bath Resistance

The FPCB assemblies bonded in accordance with the process described above were laid for 10 seconds onto a solder bath which was at a temperature of 288° C. The bond was rated solder bath resistant if there was no formation of air bubbles which caused the polyimide sheet of the FPCB to inflate. The test was rated as failed if there was even slight formation of bubbles.

Results:

For adhesive assessment of the abovementioned examples the T-peel test was conducted first of all.

The results are given in Table 1.

TABLE 1

| | T-peel test [N/cm] |
|---|---|
| Example 1 | 9.7 |
| Example 2 | 9.3 |
| Example 3 | 14.8 |
| Example 4 | 3.2 |

As can be seen, very high bond strengths were achieved in Examples 1 to 3, whereas the reference example exhibits only very low bond strengths.

The temperature stability of the adhesive tapes was measured by the static peel test, which results are given in Table 2.

TABLE 2

| | Static T-peel test |
|---|---|
| | at 70° C. [mm/h] |
| Example 1 | 5 |
| Example 2 | 7 |
| Example 3 | 12 |
| Example 4 | 36 |

As can be seen, the temperature stability of the reference specimen is significantly lower than in the case of Examples 1 to 3.

The solder bath test was passed by all 4 examples.

1. Heat-activable adhesive tape for bonding electronic components and conductor tracks, comprising an adhesive composed at least of:
a) an acid-modified or acid-anhydride-modified vinylaromatic block copolymer and
b) an epoxide compound.

2. Heat-activable adhesive tape according to claim 1, wherein the vinylaromatic block copolymer is a styrene block copolymer.

3. Heat-activable adhesive tape according to claim 1, wherein the epoxide compound is an epoxy resin and/or an epoxidized polymer.

4. Heat-activable adhesive tape according to claim 1, wherein the adhesive comprises tackifying resins, accelerators, dyes, carbon black and/or metal powders.

5. Heat-activable adhesive tape according to claim 1, wherein the adhesive crosslinks at temperatures above 150° C.

6. Heat-activable adhesive tape according to claim 1, wherein the adhesive comprises further elastomers selected from those based on pure hydrocarbons, elastomers which are essentially saturated chemically and also chemically functionalized hydrocarbons.

7. Heat-activable adhesive tape according to claim 1, wherein the adhesive comprises further acid anhydrides.

8. Heat-activable adhesive tape according to claim 1, wherein the fraction of the epoxide compound is not more than 10% by weight, based on the fraction of acid-modified and/or acid-anhydride-modified elastomer.

9. Heat-activable adhesive tape according to claim 8, wherein the fraction of the epoxide compound is not more than 5% by weight, based on the fraction of acid-modified and/or acid-anhydride-modified elastomer.

10. Method of bonding plastic parts comprising adhering a heat-activable adhesive tape according to claim 1 to said plastic parts.

11. Method of bonding electronic components and/or flexible printed circuits comprising adhering a heat-activable adhesive tape according to claim 1 to said electronic components and/or flexible printed circuits.

12. Method of bonding polyimide comprising adhering a heat-activable adhesive tape according to claim 1 to said polyimide.

13. A device comprising plastic parts, electronic components, flexible printed circuits and/or polyimide adhered to a heat-activatable adhesive tape according to claim 1.
